(19) United States
(12) Patent Application Publication
(10) Pub. No.: US 2005/0277476 A1
(43) Pub. Date: Dec. 15, 2005

(54) Computer game system and method of operation

(75) Inventor: Karl J. Wood, Crawley (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/527,889

(22) PCT Filed: Sep. 5, 2003
(86) PCT No.: PCT/IB03/03876

§ 371 Date: Mar. 15, 2005

(30) Foreign Application Priority Data
Sep. 18, 2002 (GB) 0221657.0

(51) Int. Cl. G06F 19/00; G06F 17/00

(52) U.S. Cl. 463/43

(57) ABSTRACT

A method of operating a computer game program (10;20) comprising the steps of, loading the computer game program, executing the computer game program, receiving instructions from a user interface, changing the game status according to the instructions, and charging a user to store the game status. The excitement of playing the game is increased for a user whilst increasing the profitability for right-owners of the game. The system may be an integrated computer device, such as a PC, or a distributed architecture.

This invention relates to a method of and a system for operating a computer game program.

There is much interest in manufacturing computer game systems which are appealing to potential users whilst also being profitable to the developers, manufacturers and right-owners of the game. For example, there is a wide-range of game-machines which are available for public use in, say, arcades, that operate on receipt of an initial payment from the user. The game may operate for a predetermined period or until the user makes a particular mistake in the game. This type of game system provides a profit to the owner as well as providing entertainment for the user.

Computer games can also be played on PCs and game consoles wherein a save function is provided to allow the user to store the game status indefinitely. This enables the user to return to that game status at a later time or when the next mistake is made. A pause function may also be provided.

Game systems having a distributed architecture communicating via the Internet are also known. These can comprise a remote server storing the computer game program. The game can be accessed by a user by loading the remotely stored program onto a PC or a game console for execution. The user can be charged by using a prepaid memory card or by a prearranged account processed by the remote server for example. A user can save the game status.

However, any save function encourages the user to store the game status at a difficult part of the game thus removing some of the excitement for the user. Also novice users are not encouraged to play the game as they are likely to make a mistake in the early stages requiring them to make another payment to try again and may find it difficult to progress in the game.

It is therefore an object of the invention to provide an improved method of operating a computer game program.

It is a further object of the invention to improve the profitability of a computer game system which encourages novice and expert users alike to play the game.

According to a first aspect of the present invention there is provided a method of operating a computer game program comprising the steps of:
(a)—loading said computer game program;
(b)—executing said computer game program;
(c)—receiving instructions from a user interface;
(d)—changing the game status according to said instructions, and
(e)—charging a user to store said game status.
   Advantageously, the excitement of playing the game is increased as users are charged to store the game status. When confronted with a difficult situation in the game, the user has a choice to proceed and take a chance, or to store the game state and incur a charge. This also increases the profitability of the game. Preferably, there is no charge to start playing the game. Therefore, novice users are encouraged to play and develop their progress during the early stages of the game for no charge.

Advantageously, the method may further comprise the step of (f) pausing the game status for a predetermined period of time between steps (d) and (e) in response to a specific instruction from said user interface. This allows the user to pause the game status for a short period if desired in which they may take a break. The method may further comprise the step of (g) further changing the game status according to said instructions after step (f). The user may wish to store the game status by incurring a charge immediately after the predetermined period of time or after a further period of play following a pause.

Advantageously, the method may have a multi-tier charging scale for example, in which step (e) comprises charging said user a first amount to store said game status for a predetermined time period and charging said user a second amount to store said game status for an unlimited time period. The first amount may be zero thus allowing free pauses. By making it cheaper to pause the game rather than save it then the game is made more appealing to potential users. However, the first amount preferably increases over said predetermined time period. This prevents misuse of the pause function by charging the user a greater amount for longer pauses. The user may be limited to the number of allowed pauses within a specified time period in order to prevent them from pausing the game status indefinitely by instructing many short, successive cheap pauses.

The charging may debit a user's account. This account may be credited following specific changes in the game status.

According to a second aspect of the present invention there is provided a computer game system for operating a computer game program comprising computer readable storage means arranged to store said computer game program, a processor arranged to load said computer game program from said storage means, to execute said computer game program, to receive instructions from a user interface, and to change the game status according to said instructions, and charging means for charging a user to store said game status. The system may be an integrated computer device such as a PC, game console or mobile phone, or have a distributed architecture communicating via the Internet. The charging means may comprise a cash receiver.

Embodiments of the invention will now be described by way of example with reference to the accompanying drawings, in which:

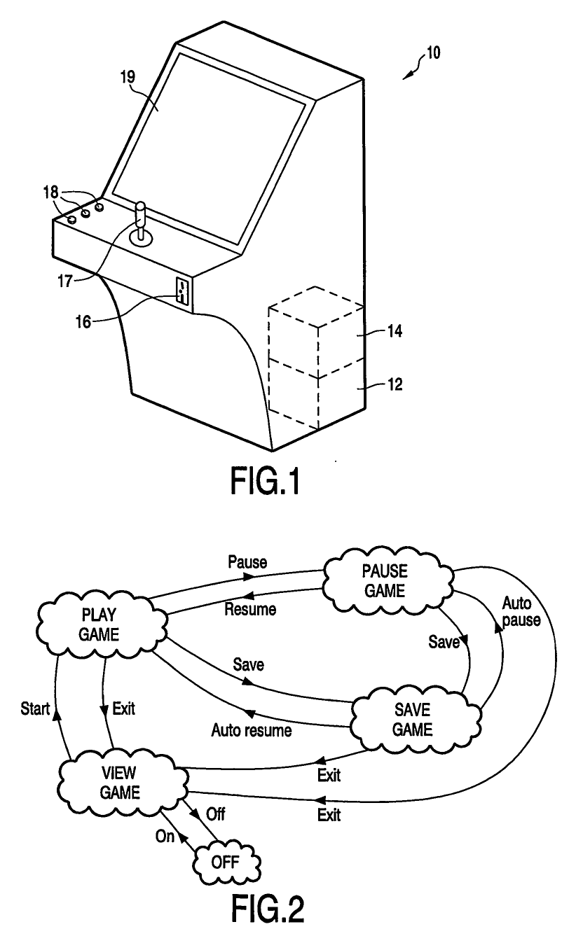

FIG. 1 shows a computer game system;

FIG. 2 is a state-machine diagram of a computer game system;

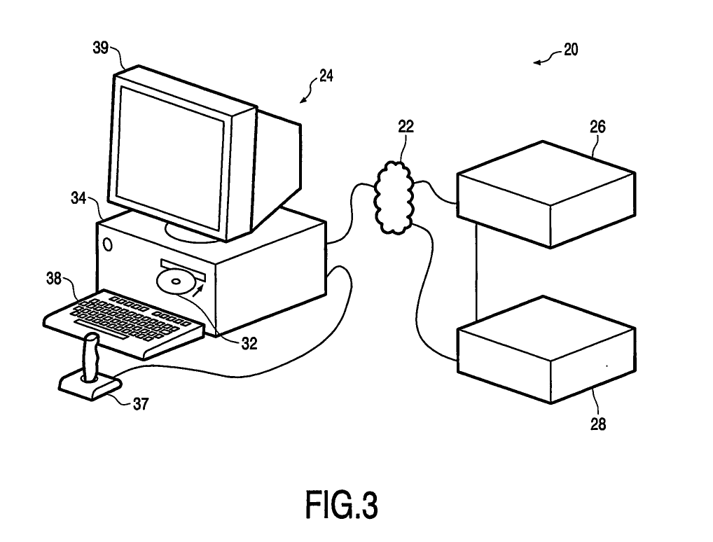

FIG. 3 shows a second embodiment of a computer game system; and,

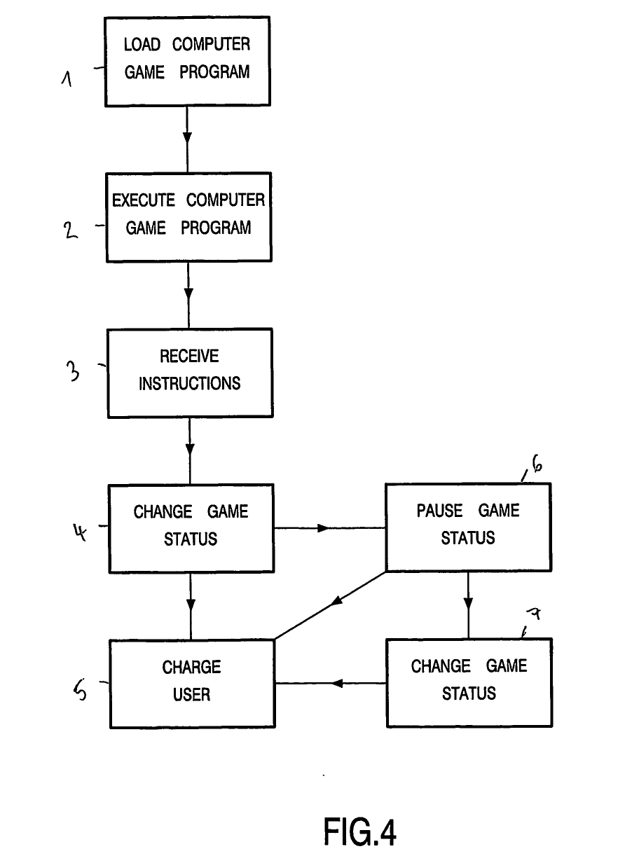

FIG. 4 is a flow diagram of a method of operating a computer game program.

FIG. 1 shows a computer game system for operating a computer game program. The system is an integrated computer device in the form of stand-alone arcade-style game machine 10. The machine 10 comprises computer readable storage means 12 arranged to store the computer game program. The storage means 12 may comprise an optical or magnetic disc or a memory cartridge for example. A processor 14 is arranged to load the computer game program, from the storage means 12, to execute the computer game program, to receive instructions from a user interface, and to change the game status according to the instructions. The machine 10 also has charging means in the form of a cash receiver 16. The user-interface of the machine 10 comprises a joystick 17 and buttons 18. The game status can be viewed on a display 19.

There are various ways in which a user can operate such a system in which there may be the option to carry out different actions at a given point in the operation. The state-machine diagram of FIG. 2 illustrates, by way of example, some of the actions which a user of a computer game system may carry out. Once the system has been switched on, the available game can be viewed on the display 19 for example. The game may then be started following an instruction from the user. At any point during the game the user may pause, save or exit the game. Some actions may be automatic thus not requiring an instruction from the user. This includes an auto-pause following the saving of the game status allowing the user to re-gather their thoughts before resuming.

An example method of operating a computer game program on the system of FIG. 1 will now be described.

The processor 14 loads the computer game program from the storage means 12, and executes the game on the system. The game is advertised on the display 19 by showing an introductory page of the game for example, which may attract potential users. A user may then start to play the game, free of charge, sending the desired instructions to the processor by operating the joystick 17 and/or the buttons 18. The processor 14 receives these instructions from the user-interface and changes the game status according to the instructions. The game status is continually displayed to the user, on the display 19. Sound output may also be provided by the machine and the joystick 17 may have feedback functionality wherein it provides varying degrees of movement resistance to the user depending on the game status.

At some stage in the game the user may wish to save the game as shown on the state-machine diagram of FIG. 2 as a “save” action carried out by the user. This may be just before a difficult part of the game in which there is a high risk that the user will make a mistake resulting in a restart of the game. Instead, the user may wish to save the game because they want to end that particular play session and resume with that game status at a later time. The user is charged to store the game status and therefore makes a payment by inserting cash into the cash receiver 16 and which payment is registered by the processor 14. This triggers the processor to store the game status on the storage means 12. The user then has a choice to continue playing the game or to end that play session.

By charging the user to store the game status at a high risk part, the dramatic tension is maintained. The user is also allowed to save the game at the end of a play session at a cost. Income is generated for the owner of the game machine 10 when a user stores the game status. The game can be played free of charge. Advantageously, this encourages novice users to start playing the game. The introductory page may attract new users by displaying a “Free to Play” sign.

As an alternative arrangement of the charging means, the processor 14 may register an account for the user which is stored and updated locally. For example, the amount in the account is increased when the user inserts cash into the cash receiver 16 at any time. Also, the user's account is credited following specific charges in the game status such as the collection of a valuable object in the game. The user is charged to store the game status by debiting the user's account.

FIG. 3 shows another computer game system for operating a computer game program. The system 20 has a distributed architecture communicating via the Internet 22 and comprises a PC 24, a server 26, and charging means in the form of an on-line account 28, each remote from one another. The PC 24 comprises computer readable storage means in the form of a CD-ROM 32, arranged to store the computer game program. At least a part of the computer game program may also be stored on a DVD-ROM, a hard-drive and/or the server 26. The PC 24 further comprises a processor 34 arranged to load the computer game program from the storage means, to execute the computer game program, to receive instructions from a user interface, and to change the game status according to the instructions. The user interface comprises a joystick 37 and a keyboard 38 both connected to the processor 34 either by a wired connection, as shown, or by a wireless link. The PC 24 further comprises a monitor 39.

The on-line account 28 communicates with the PC 24 via the Internet 22 and with the server 26 either directly, as shown, or via the Internet 22.

An example method of operating a computer game program on the system of FIG. 3 will now be described with reference also to the flow-diagram shown in FIG. 4. The processor 34 loads the computer game program from the CD-ROM 32 and executes the computer game program.

The user plays the game free of charge and the game status is communicated to the user by displaying it on the monitor 39. Instructions and game data are received by the processor 34 from the remote server 26 via the Internet through a secure wired connection as shown and/or via a wireless connection.

These instructions and data may be encrypted to prevent the misuse by hackers for example. The processor 34 receives instructions from the user interface, by way of the user operating the joystick 37 and the keyboard 38, and changes the game status according to these instructions. At some stage in the game the user may wish to pause the game by storing, or freezing, the game status for a short period in order to take a short break. The state-machine diagram of FIG. 2 shows this as a “Pause” action carried out by the user. This allows the user to answer an incoming telephone call for example. Also, the user may pause the game when a quick decision is required. The game status is paused for a predetermined period of time in response to a specific instruction from the user interface which may be a command from the user entered on the keyboard 38 for example. Whilst the game status is paused, it is stored by the processor 34 on computer readable storage means either locally or remotely via the Internet 22.

Following the pause, the user may resume the game by giving another specific instruction to the processor 34 via, say, the keyboard 38. The game status is then further changed according to instructions received from the user.

The user may wish to save the game for similar reasons as described above for the system of FIG. 1, and is charged to store the game status.

Following an instruction from the user, the on-line account 28 is debited with the charged amount. The server communicates with the account and registers the debiting of the account and triggers the processor to store the game status.

A multi-tiered charging scheme may be adopted by charging the user a first amount to store the game status for a predetermined time period, wherein the game is paused for example, and charging the user a second amount to store the game status for an unlimited time period, wherein the game status is saved for example. The first amount may be zero where the user may pause the game free of charge. However, in order to dissuade the user from pausing the game indefinitely, the first amount may increase over the predetermined time period thus making it more expensive for longer pauses. A limit could be imposed on the number of allowed pauses during a specified time period to prevent the user from taking many short, therefore free, consecutive pauses.

To summarise the system of FIG. 3, the user is charged to store the game status for an unlimited time period and payment is made by an on-line account 28 which is in communication with a remote server 26 and the PC 24 via the Internet. The game status may be paused for a predetermined time period which is free for short periods.

Although the distributed architecture of FIG. 3 communicates via the Internet, it is envisaged that other wired or wireless networks could be used instead. Examples of which include private, global and company intranets which do not form part of the Internet as such.

Variations to the embodiments described will be apparent to those skilled in the art. The system may comprise a game console, a mobile phone or a PDA. The computer game program may be stored locally, such as on a PC, or remotely at a central server for example. The user may be charged by debiting an account either locally by using a prepaid memory card for example or remotely by using a credit card for example.

1. A method of operating a computer game program comprising the steps of:
(a)—loading said computer game program;
(b)—executing said computer game program;
(c)—receiving instructions from a user interface (17,18);
(d)—changing the game status according to said instructions, and
(e)—charging a user to store said game status.

2. A method according to claim 1, further comprising the step of:
(f)—pausing the game status for a predetermined period of time between steps (d) and (e) in response to a specific instruction from said user interface.

3. A method according to claim 2, further comprising the step of:
(g)—further changing the game status according to said instructions after step (f).

4. A method according to claim 1, 2 or 3, wherein step (e) comprises charging said user a first amount to store said game status for a predetermined time period and charging said user a second amount to store said game status for an unlimited time period.

5. A method according to claim 4, wherein said first amount increases over said predetermined time period.

6. A method according to any preceding claim, wherein said charging is debiting a user's account.

7. A method according to claim 6, wherein said user's account is credited following specific changes in the game status.

8. A computer game system 10;20 for operating a computer game program comprising computer readable storage means 12 arranged to store said computer game program, a processor 14 arranged to load said computer game program from said storage means 12, to execute said computer game program, to receive instructions from a user interface 17,18, and to change the game status according to said instructions, and charging means 16;28 for charging a user to store said game status.

9. A computer game system 10 according to claim 8, wherein said system is an integrated computer device.

10. A computer game system 20 according to claim 8, wherein said system has a distributed architecture communicating via the Internet 22.

11. A computer game system according to claims 8, 9 or 10, wherein said charging means debits a user's account 28.

12. A computer game system according to any one of claims 8 to 11, wherein said charging means comprises a cash receiver 16.

13. A computer game program for carrying out any one of the methods of claims 1 to 7.
